(19) United States
(12) Patent Application Publication
(10) Pub. No.: US 2007/0069883 A1
(43) Pub. Date: Mar. 29, 2007

(54) Product display system and container

(76) Inventors: Bill G. Collier JR., Old Hickory, TN (US); Brent D. Holmes, Brentwood, TN (US); David B. Holmes, Mobile, AL (US); Michael W. Starkweather, Sandy, UT (US); Jason P. Webb, Salt Lake City, UT (US)

Correspondence Address: Starkweather & Associates;Suite 200, 9035 South 1300 East, Sandy, UT, 84094, US

(21) Appl. No.: 11/234,791

(22) Filed: Sep. 23, 2005

(51) Int. Cl. G08B 1/08

(52) U.S. Cl. 340/538

(57) ABSTRACT

There is a product display system and container for holding contents. The container includes a housing configured to contain the product; a power source coupled to the housing and configured to provide electrical power; an electronic paper display coupled to the housing, electrically coupled to the power source, and configured to visually display first and second images; a processor in electrical communication with the electronic paper display and configured to control display of the first and second images; and/or a memory module in communication with the electronic paper display and configured to store information regarding the first and second images. There is an activation module in electrical communication with the electronic paper display, the processor, and the power source, wherein the activation module is configured to selectably restrict power consumption from the power source. There is also a solar cell for recharging the power source.

### BACKGROUND OF THE INVENTION

1. Field of the Invention

The present invention relates to containers, specifically to containers and product display systems having changing and/or changeable displays.

2. Description of the Related Art

In a retail environment, the ability to stand out above competitors is vital to successful sales. Various methods, systems and devices are used to increase the visibility of products. Such include signs, display orientation, lights, bright colors, and 3-dimensional displays associated with products.

US Patent Application No. 2004/0246684 by Karaki discloses a sheet computer, wearable computer, display device, fabrication methods, and electronic devices thereof that eliminate the drawback in operational speed caused by clock delays of a system clock and that is capable of high speed operation. In order to achieve this object, a display circuit and peripheral circuits connected to the display circuit are fabricated on the same substratum and the peripheral circuits constitute an asynchronous system without global clocking. In the asynchronous system, processes constituting minimum function circuits perform mutual handshaking by channels and drive events actively or passively. The asynchronous system does not use global clocking and it is therefore possible to implement lower power consumption and a higher operational speed.

US Patent Application No. 2005/0041091 by Sawyer discloses a drive capable of printing a label on a unit of optical media. The drive includes a first head optically communicating with the media on a first side and a second label printing head for applying a visual label associated with the unit of optical media on a second side while the media is in an operational position. The first head includes an optical read-only head or read-write head. The second label printing head includes a fixed or movable print head, thermal, ink jet, or laser print head. The second head can communicate through electrical contacts or a wireless interface with a circular film having addressable elements capable of being addressed and providing a visual display via liquid crystal elements.

U.S. Pat. No. 6,333,754 to Oba et al. discloses an image displaying apparatus, a method for displaying an image and an image displaying medium can provide an image of a large viewing angle and high stability of the particles upon repeated use. On electronic paper containing a display substrate formed of a hole transporting film, a non-display substrate formed of a film having a two-layer structure containing a charge transporting film having formed thereon an electrode layer having a thickness of about 50 mm, and conductive black particles and insulating white particles contained therebetween, an electric field is generated at a position corresponding to image data by a recording head, so as to move the black particles attached to the entire surface of the display substrate toward the non-display substrate, whereby an image of contrast of black and white is formed on the display substrate.

Some problems associated with such methods and devices include inefficient power consumption, displays too visually aggressive once an initial glance is caught, inability to adapt to various products, inability to generalize to multiple products, and failure to direct attention and/or maintain customer attention directly to purchasable product.

What is needed is a product display system and/or a container that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available containers. Accordingly, the present invention has been developed to provide a product display system and/or container with a changing display.

In one embodiment there is a container for holding a product. The container includes a housing configured to contain the product; a power source coupled to the housing and configured to provide electrical power; an electronic paper display coupled to the housing, electrically coupled to the power source, and configured to visually display a first image; and a second image; a processor in electrical communication with the electronic paper display and configured to control display of the first and second images; and/or a memory module in communication with the electronic paper display and configured to store information regarding the first and second images.

There may also be an activation module in electrical communication with at least one of the group consisting of the electronic paper display, the processor, and the power source, wherein the activation module is configured to selectably restrict power consumption from the power source. The activation module may include a light detector. The activation module may permit power consumption when light is detected and may restrict power consumption when light is not detected.

There may also be a solar cell electrically coupled to the power source and configured to provide power to the power source when exposed to light. There may be an interface module that may be a tab that may be in removably communication with the memory module. There may be a second electronic paper display coupled to the housing, electrically coupled to the power source, and/or configured to visually display a third image; and a fourth image. There may be a protective coating disposed over the electronic paper display.

In another embodiment there may be a product display system for attaching to a product. The product display system may include a power module configured to provide power; a display module in electrical communication with the power module and configured to selectably display visual information; an operating module in communication with the display module and configured to control the display module; and/or a coupling module coupled to each of the power module, the display module, and the operating module and configured to couple the product display system to the product.

The coupling module may be coupled indirectly to the power module. The coupling module may include an adhesive layer coupled to the display module; and/or a release layer coupled to the adhesive layer and configured to be removed without substantially removing the adhesive layer thereby exposing the adhesive layer. There may also be a backlight module disposed behind the display module and configured to emit light through the display module. There may be an interface module removably coupled to the operating module and in communication therewith. The interface module may include a perforated tab extending from the operating module. The power module may include a sheet battery.

In still another embodiment, there is a product display system for containing a product. The product display system may include a power module configured to provide power; display module in power communication with the power module and configured to selectably display visual information; an operating module in communication with the display module and configured to control the display module; and/or a housing module coupled to the display module and configured to contain the product.

The product display system may further include a recharging module in electrical communication with the power module and/or configured to supply power to the power module. The housing module may be substantially ensconced by the display module. The display module may include a protective sleeve. There may also be an interface module removably coupled to the operating module and in communication therewith. The display module may include electronic paper.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates a container having a changing display according to one embodiment of the invention;

FIG. 2 is a block diagram illustrating a modular view of a container having a changing display according to one embodiment of the invention;

FIG. 3 illustrates a sheet battery according to one embodiment of the invention;

FIG. 4 illustrates a thin display according to one embodiment of the invention; and

FIG. 5 illustrates a solar cell according to one embodiment of the invention.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

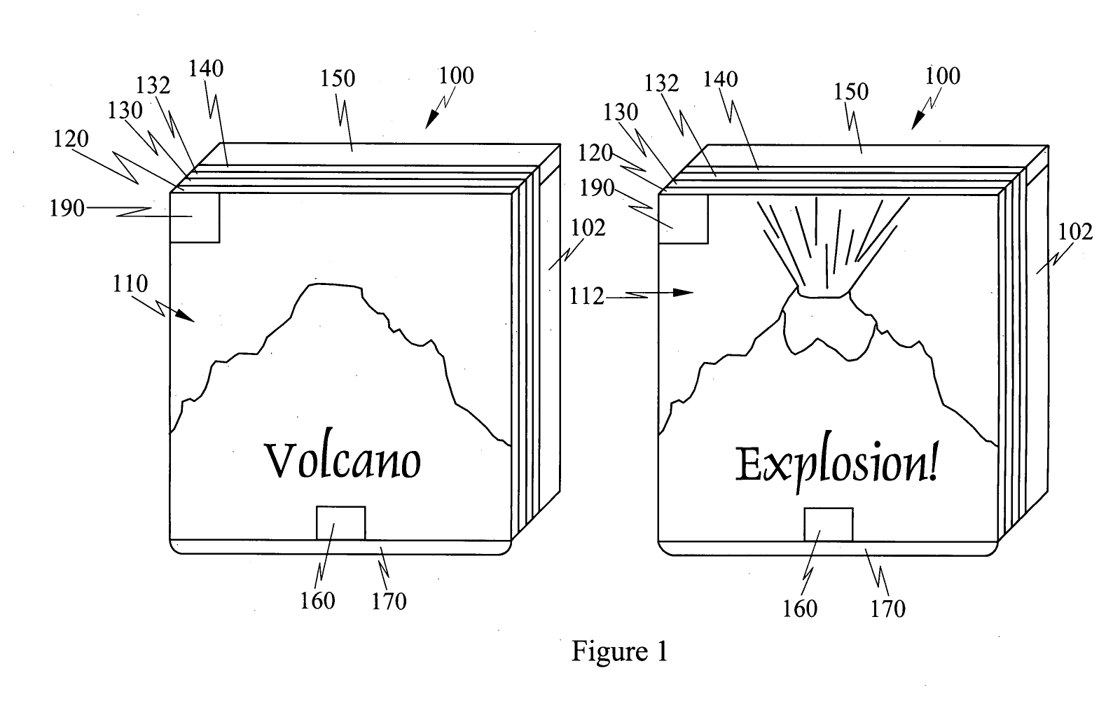

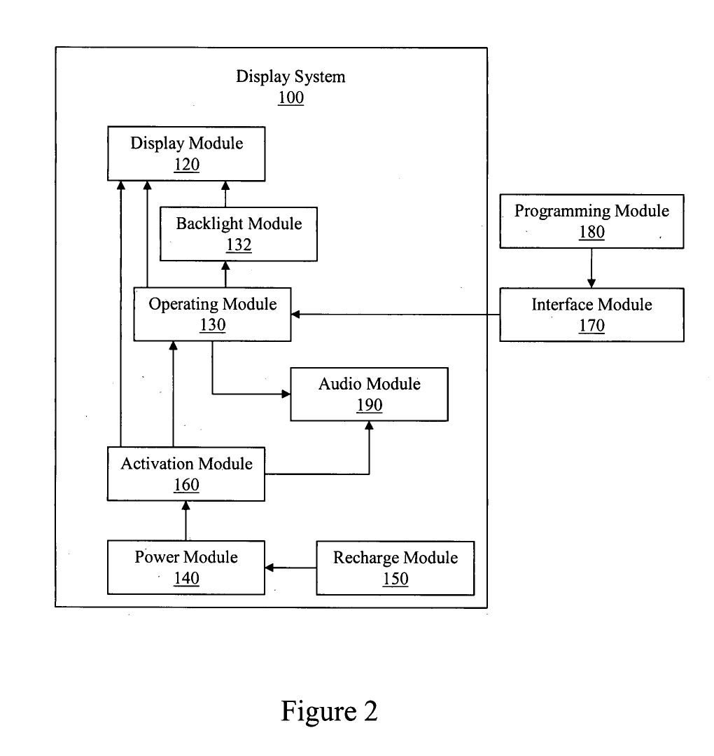

FIGS. 1 and 2 illustrate a product display system having a changing display according to one embodiment of the invention and a block diagram illustrating a modular view of a container having a changing display according to one embodiment of the invention, respectively. There is shown a container or product display system 100 having a first image 110 and a second image 112 each displayed on a display module 120. A container 100 may contain object(s) and or other content such as written materials. The display module 120 is coupled to an operating module or control module 130. The operating module 130 may include a processor or processor module, memory or memory module, and/or a transducer or transducer module.

In one non-limiting example a memory module may include an instruction set associated with an image and the processor module may direct the transducer module to alter the display module 120 according to the instruction set of the memory module thereby forming a desired image in the display module 120. Together, the operating module 130 and the display module 120 may be what is known in the art as electronic paper such as that described in U.S. Pat. No. 6,865,012 to Liang et al. and U.S. Pat. No. 6,914,713 to Chung et al. which patent specifications are incorporated by reference herein. Electronic paper may be generally described as a multiplicity of cells each including a fluid and one or more particles responsive to a stimulus such as a voltage or magnetic field. Typically, the particle includes a plurality of stable states including one wherein the particle is visible and one wherein the particle is not visible. Accordingly, a user may use a stimulus to alter the particle to one state or another wherein the particle may remain until otherwise stimulated. Therefore, a series of images may be generated by altering states of a plurality of particles. In some examples, electronic paper may include a plurality of colors, may be flexible, may present a non-emissive image, and/or may display an image without continuously consuming power.

The operating module 130 may include an instruction set and/or logic control such that the operating module 130 may cause images to change according to a defined pattern. In one non-limiting example, the operating module 130 may cause an increase in frequency of image changes for a few seconds out of each minute, accordingly drawing increased attention to the product display system 100 during such time.

There is also shown a backlight module 132 that may be configured to emit light through the display module 120 and/or operating module 130. The backlight module 132 may include parameters that may be variable such as but not limited to brightness, color, and strobe frequency. The backlight module 132 may be configured to not shine through the display module 120 and/or operating module 130 but to instead provide a glowing border thereabout to advantageously attract additional attention to the product display system 100.

The electronic paper 120 and 130 or display module 120 and operating module 130 is shown electronically coupled to a power source or power module 140 such as but not limited to a thin film sheet battery, a button type battery, a power supply, a DC power source, an AC power source, and/or any combination thereof. A power module 140 may include one or more power sources such as but not limited to batteries. In another non-limiting example a power module is a solar cell. It is preferred that the power module 140 be coupled at least indirectly to the housing or coupling module 102. An example of such a battery may be found in U.S. Pat. No. 6,608,464 to Lew at al. the specification of which is incorporated by reference herein. The power source 140 is coupled to a product or product housing 102 such as but not limited to a CD/DVD case, a book, a greeting card, a billboard, a cereal box, a sign, and a toy/game carton/box. The power module 140 may include a power indicator such as a battery level indicator such as those sold under the name SAA1501T by Phillips Electronics having an office located at Groenewoudseweg 1, 5621 BA, Eindhoven in the Netherlands. A power indicator may be a thin strip coupled to a surface of a product and/or a surface of a product display system 100.

There is also shown a recharging module 150 coupled to the housing 102 and the power source 140. The recharging module 150 is configured to provide power to or recharge the power module 140. In one non-limiting example, the recharging module 150 is a thin solar panel or photovoltaic thin-film cell configured to provide a source of power to the power module 140 such as by recharging a battery in the power module 140. A non-limiting example of a photovoltaic thin-film cell includes the photovoltaic thin-film cell disclosed in US Patent Application No. 2005/0183768 by Roscheisen et al. the specification of which is incorporated by reference herein.

Disposed on a front of the container 100 is shown an activation module 160. An activation module 160 may include a sensor such as but not limited to a light detector, motion detector, or pressure detector coupled to one or more of the display module 120, operation module 130, and power module 140 in such a way as to regulate power consumption from the power module 140. The activation module 160 may be in communication with the operation module 130 and/or may trigger or toggle one or more changes in the visual display 120 including but not limited to changing an image and changing a frequency of display of images. In one non-limiting example, the activation module 160 may be a light sensor that may restrict power flow from the power module 140 when light is not detected and/or only detected below a defined threshold. Accordingly, when a product may be being shipped, stored, or may not be prominently displayed, power is not consumed. In another non-limiting example, an activation module may restrict power from being drawn from the power module 140 until an action is performed, such as but not limited to removing a piece of tape from the activation module 160.

In another non-limiting example, the activation module 160 may include a pressure sensor, such as but not limited to contact points, a button, or squeeze actuatable switch or toggle. Accordingly, in one non-limiting example, a viewer may be presented with a visual display that may increase in activity when a “squeeze-me” button is actuated. Actuation of such may cause a display module to change one or more images and may cause images to change a plurality of times over a period of time. In another example, actuation of the activation module 160 may cause the audio module 190 to emit or not to emit a sound. Such may also include wherein the visual display may change images at a first frequency and actuation of the activation module 160 may cause the visual display to change images at a second frequency. In one non-limiting example the second frequency is greater (more rapid) than the first frequency. In another example, there may be a flap, such as but not limited to the front panel of a greeting card, wherein opening of the flap may actuate the activation module 160 and may result in one or more image changes as described above.

Therefore, a product display system 100 may have a plurality of activity levels, such as but not limited to a storage level wherein images do not change and power is not substantially consumed, a display level wherein images change at a rate sufficient to attract attention, and an enhanced level wherein images change more quickly and/or previously un-displayed images may display upon actuation of a sensor in an activation module 160 by a viewer.

Coupled to the operating module 130 is shown an interface module or interface tab 170. The interface tab 170 is configured to enable an operator to interface with the operating module 130 through a programming module 180 to perform one or more tasks such as but not limited to programming, diagnostics, loading/clearing memory, and changing operating parameters. In one non-limiting example the interface tab 170 is a strip of material including conductive leads in electrical communication with the operating module 130. There may be a perforation along the interface tab 170 such that the interface tab 170 may be easily removed from the container 100. The interface tab 170 may be configured to mate with a programming module 180 that may be another device coupled to a computer for facilitating operator functions. An interface tab 170 may be configured to receive data from the internet, a console, a desktop computer, etc. Further, an interface tab 170 may be configured to receive information by a variety of file types such as but not limited to jpg, TIFF, GIF, drafting files, EPS, WAV, MP3, etc. Still further, an interface module 170 may be an I/O device that may permit interfacing the operating module by any means of communication, including but not limited to IR, RF, and electrical communication.

Also shown is an audio module 190 configured to emit audio. The audio module 190 is shown on a front of the product display system 100 but may be disposed anywhere. Preferably the audio module 190 is disposed on the product display system 100 such that sound from the audio module is not substantially distorted and/or muted. In one non-limiting example, the audio module 190 is coupled to a top front of the display module 120. In one non-limiting example, audio module 190 may be in communication with the operation module 130, the power module 140, and/or the activation module 160. Accordingly, the audio module 190 may be controlled in ways similar to control of the display module 120 as described herein. In one non-limiting example, the audio module 190 includes memory for storing audio play instructions.

The display module 120 may include a protective member, such as a sleeve and/or protective coating. Such may be but is not limited to a sleeve coupled to the housing into which other components of the product display system 100 may be disposed. Examples of protective members include but are not limited to substantially transparent or translucent plastic sheets or laminates.

In operation, a user may couple a product display system 100 to a container such as by a pressure adhesive or may have a product display system 100 having a container attached. In one non-limiting example, a product display system may include an adhesive layer coupled to a module of the product display system 100, such as the power module 140, and may further include a release layer coupled to the adhesive layer such that the release layer may be removed, thereby exposing the adhesive layer which may then be disposed on a surface of a container, thereby coupling the product display system to the container. In another non-limiting example, the coupling module and/or adhesive layer may be disposed on a front surface of the display module 120 such that the display module 120 may be coupled to a surface, such as but not limited to being coupled to a glass pane.

The product display system 100 may be programmed with a first image 110 to be displayed and a second image 112 to be displayed. An object or other content may be included in the product display system 100, such as but not limited to placing a particular DVD into the housing 102. The product display system 100 may be shipped to a vendor location, such as but not limited to a retailer, where the product display system 100 may be displayed and offered for sale packaged with the contents of the housing. The activation module 160 may be used to conserve power in the power module 140, for example by only allowing the electronic paper to change between the first and the second images 110 and 112 in circumstances where the product display system 100 is at least partially viewable by a potential buyer.

There may be a plurality of display modules 120 coupled to a container. In one non-limiting example, there is a pair of display modules 120 each controlled by a single operating module 130. A display module 120 may only cover a small portion of a container. In another example, a display module 120 may substantially enclose, envelope, or contain a container. In a further example, a container may be a DVD case as is commonly known in the art and a product display system may be slipped between a protective member on the DVD case and the product display system may wrap around, substantially covering a majority of the exposed surface of the closed container.

In a still further example, a product display system 100 may ensconce product or a container, wherein the product/container is substantially covered and/or nestled within the product display system 100, such as where the product display system 100 may be configured as a bag. In a still yet further example, there may be a product that is a greeting card having an aperture through a front panel wherein a display member 120 may be coupled to the front of a back panel and may display through the aperture of the front panel. More, an activation module 160 may detect an opening of the greeting card and may cause a second image to be displayed and/or a series of images to be displayed.

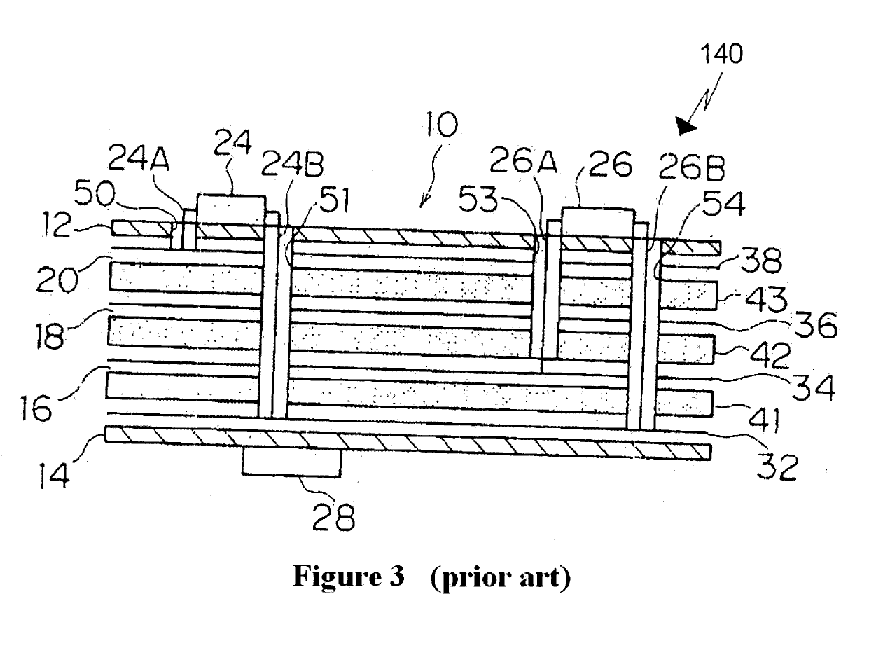

FIG. 3 illustrates a sheet battery 140 according to one embodiment of the invention. A layered substrate 10 in FIG. 3 has an upper substrate 12, a lower substrate 14, and three sheet batteries 16, 18, and 20 between the substrates 12 and 14. ICs 24 and 26 are disposed on the upper substrate 12 as electronic parts, and voltages of the ICs 24 and 26 are, for example, 5.0 V and 2.0 V, respectively. A reference number 28 is an IC which is disposed on the lower substrate 14.

In FIG. 3, the batteries 16, 18, and 20 are called, from the bottom to the top, the first sheet battery 16, the second sheet battery 18 and the third sheet battery 20. In this embodiment, the voltages of the first sheet battery 16, the second sheet battery 18, and the third sheet battery 20 are 2.0 V, 1.3 V, and 1.7 V, respectively, and the sheet batteries 16, 18, and 20 are connected in series.

The sheet batteries 16, 18, and 20 are disposed while being firmly contacted between the upper substrate 12 and the lower substrate 14. Reference numbers 32, 34, and 36 are electrode plates for the sheet batteries 16, 18, and 20, respectively, and reference numbers 41, 42, and 43 are battery media. The electrode plate 34 is used for both a cathode of the first sheet battery 16 as well as an anode of the second sheet battery 18, and the electrode plate 36 is used for both a cathode of the second sheet battery 18 as well as an anode of the third sheet battery 20.

On the layered substrate 10, holes 50 and 51 for power connect wires 24A and 24B of the IC 24, and holes 53 and 54 for power connect wires 26A and 26B of the IC 26 are formed. The hole 50 reaches a cathode plate 38 of the third sheet battery 20, whereas the hole 51 reaches an anode plate 32 of the first sheet battery 16. The power connect wire 24A is inserted through the hole 50 to the electrode plate 38. The power connect wire 24B is inserted through the hole 51 to the electrode plate 32. The voltage of 5.0 V is thereby supplied to the IC 24.

Now viewing the hole 53, it reaches the cathode plate 34 of the second sheet battery 18, whereas the hole 54 reaches the electrode plate 32 of the anode plate 32 of the first sheet battery 16. The power connect wire 26A of the IC 26 is inserted through the hole 53 to the electrode plate 34. The power connect wire 26B is inserted through the hole 54 to the electrode plate 32. The voltage of 2.0 V is thereby applied to the IC 26. Although not shown in the drawing, a hole reaches the cathode plate 34 of the second sheet battery 18 in a case that 3.3 V is required.

In the layered substrate 10 which is constructed as described above, the sheet batteries 16, 18, and 20 are sandwiched between the upper substrate 12 and the lower substrate 14 in layers, and thus the layered substrate 10 with a substrate and batteries integrated is constructed. Thus, the powers can be directly supplied from the sheet batteries 16, 18, and 20 to the substrates 12 and 14. In particular, the sheet batteries 16, 18, and 20 are connected in series and layered, and necessary electrode plates 32, 34, 36, and 38 are connectable via the holes 50, 51, 53, and 54; hence a plurality of voltages can be drawn corresponding with depths of the holes.

The sheet batteries 16, 18, and 20 of the layered substrate 10 can be so designed as to adjust capacity suitable for the respective loads. Because the sheet batteries 16, 18, and 20 are integrated as the layered substrate 10, exchanging of batteries is difficult; however, a secondary battery is used as a sheet battery and a charging circuit (not shown) may be provided within a device in which the layered substrate is incorporated. This makes the sheet batteries rechargeable, and the sheet batteries can be reused.

According to the present embodiment, the voltages for the substrates can be applied without a DC converter; consequently, the electronic device can be thinner and at the same time the circuit structure can be simplified.

In the above description, the three sheet batteries 16, 18, and 20 are presented, but the number of the sheet batteries is not limited to three, and it may be any if more than one. The voltages of the sheet batteries may be uniform, or may be different. In FIG. 3, the sheet batteries 16, 18, and 20 are sandwiched between the upper substrate 12 and the lower substrate 14, but either of the substrates 12 and 14 may be omitted.

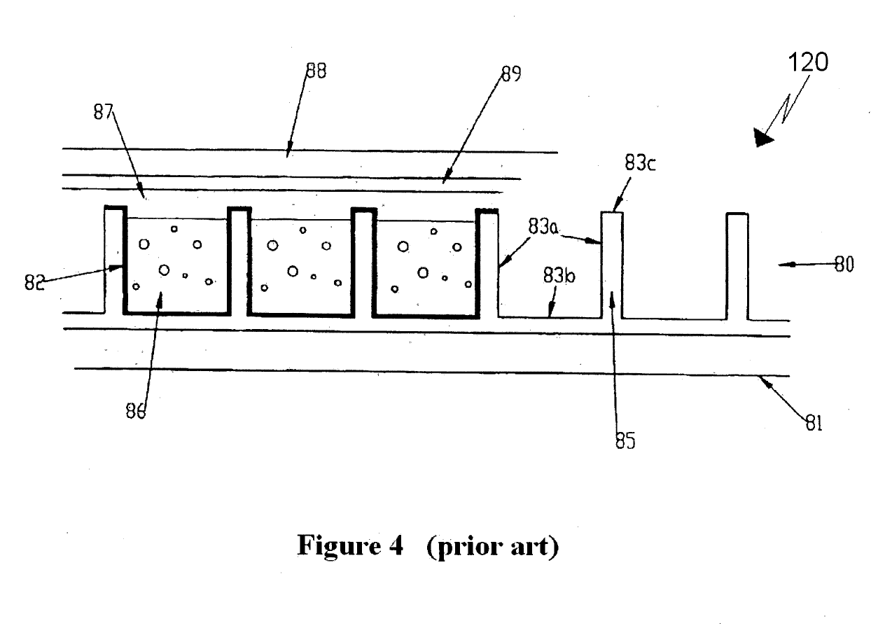

FIG. 4 illustrates a thin display 120 according to one embodiment of the invention. There is an electrophoretic display (EPD) that is a non-emissive device based on the electrophoresis phenomenon of charged pigment particles suspended in a solvent. Such a display usually comprises two plates with electrodes placed opposing each other, separated by using spacers. One of the electrodes, typically on the viewing side, is transparent. For the passive type of EPDs, row and column electrodes on the top (the viewing side) and bottom plates respectively are needed to drive the displays. In contrast, an array of thin film transistors (TFT) on the bottom plate and a common, non-patterned transparent conductor plate on the top viewing substrate are required for the active type EPDs. An electrophoretic fluid composed of a colored dielectric solvent with charged pigment particles dispersed therein is enclosed between the two electrodes.

When a voltage difference is imposed between the two electrodes, the pigment particles migrate by attraction to the plate of polarity opposite that of the pigment particles. Thus the color showing at the transparent plate, determined by selectively charging the plates, can be either the color of the solvent or the color of the pigment particles. Reversal of plate polarity will cause the particles to migrate back to the opposite plate, thereby reversing the color. Intermediate color density (or shades of gray) due to intermediate pigment density at the transparent plate may be obtained by controlling the plate charge through a range of voltages.

EPDs of different pixel or cell structures have been reported previously, for example, the partition-type EPD (M. A. Hopper and V. Novotny, IEEE Trans. Electr. Dev., 26(8):1148-1152 (1979)) and the microencapsulated EPD (U.S. Pat. Nos. 5,961,804, 5,930,026 and 6,017,584).

FIG. 4 illustrates an electrophoretic display prepared by an alternative process. In this process, an array of microcups (80) are formed directly on a first non-conducting substrate (81). Useful non-conducting substrates may include, but are not limited to, glass, metal sheets or films overcoated or laminated with a non-conducting or dielectric layer, and plastic films such as epoxy resins, polyimide, polysulfone, polyarylether, polycarbonate (PC), polyethylene terephthalate (PET), polyethylene terenaphthalate (PEN), poly(cyclic olefin) and composites thereof.

The microcups may be formed by any of the methods as described in Section I. After the formation of the microcups, a first conductor layer (82) is formed on the surface (83) of the microcups which includes the side surface (83a), the bottom surface (83b) and the top surface (83c) of the partition walls (85). In one embodiment, the first conductor layer may be formed on only the side surface (83 a) and the bottom surface (83b). In another embodiment, the first conducting layer may be formed on the side surface (83a), bottom surface (83b) and the top surface (83c) of the partition walls and in this case the first conducting layer on the top surface (83c) of the partition walls may be later removed.

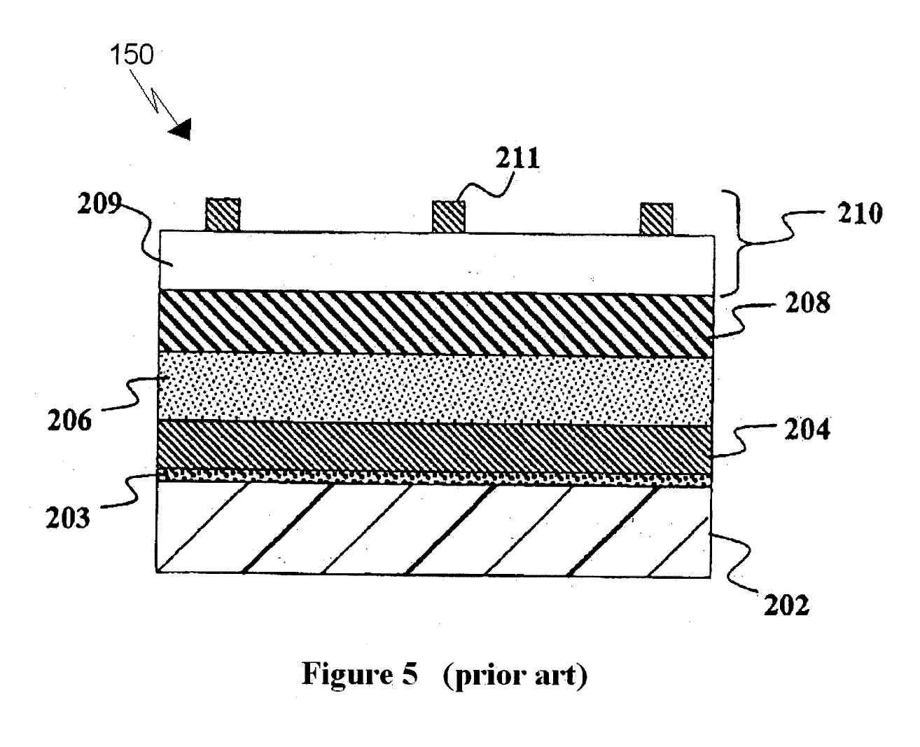

FIG. 5 illustrates a solar cell 150 according to one embodiment of the invention. An IB-IIIA-VIA alloy layer can be used in the active layer of photovoltaic cell. The solar cell 200 generally includes a substrate or base layer 202, a base electrode 204, a IB-IIIA-VIA layer 206, a window layer 208, and a transparent electrode 210. The base layer 202 may be made from a thin flexible material suitable for roll-to-roll processing. By way of example, the base layer may be made of a metal foil, such as titanium, a polymer such as polyimide or a metallized plastic. The base electrode 204 is made of an electrically conducive material. By way of example, the base electrode 204 may be a layer of stainless steel or molybdenum, e.g., about 0.5 microns to about 1 micron thick.

By way of example, and without limitation, the IB-IIIA-VIA layer 206 may include material of the general formula CuIn₁-xGaₓ(S or Se)₂. The IB-IIIA-VIA layer 206 may be fabricated by depositing a film of a molten mixture, e.g., roughly 1 to 10 microns thick on the base electrode 204. The film may be cooled to solidify the IB-IIIA-VIA layer 206. The IB-IIIA-VIA layer 206 may be about 1 micron to about 4 microns thick after cooling. By using a molten mixture of the type described above, the IB-IIIA-VIA layer 206 may be formed at a temperature compatible with the underlying substrate 202 and electrode 204. An optional adhesion layer 203 may facilitate bonding of the electrode 204 to the substrate 202.

After annealing, the film may optionally be exposed to selenium vapor at about 300-500 degrees C. for about 3045 minutes to ensure the proper stoichiometry of Se in the film. To carry out such a Se vapor exposure, the film, if deposited on a flexible substrate, can be wound into a coil and the coil can be coated so that the entire roll is exposed at the same time, substantially increasing the scalability of the Se vapor exposure process through such a high-volume batch process, e.g., as described above.

The window layer 208 is typically used as an interface between the band gaps of the different materials making up the IB-IIIA-VIA layer 206. By way of example, the window layer may include cadmium sulfide (CdS), zinc sulfide (ZnS), or zinc selenide (ZnSe) or some combination of two or more of these. Layers of these materials may be deposited, e.g., by chemical bath deposition, typically to a thickness of about 50 nm to about 100 nm.

The transparent electrode 210 may include a transparent conductive oxide layer 209, e.g., zinc oxide (ZnO) or aluminum doped zinc oxide (ZnO:Al), which can be deposited using any of a variety of means including but not limited to sputtering, evaporation, CBD, electroplating, CVD, PVD, ALD, and the like. If the substrate is flexible and the deposition technique is ALD or CBD or the like, a coiled/wound flexible substrate can be exposed so that the entire roll is processed at one time, e.g., as described above. The transparent electrode 210 may further include a layer of metal (e.g., Ni, Al or Ag) fingers 211 to reduce the overall sheet resistance.

An optional encapsulant layer (not shown) provides environmental resistance, e.g., protection against exposure to water or air. The encapsulant may also absorb UV-light to protect the underlying layers. Examples of suitable encapsulant materials include one or more layers of polymers, such as tetrafluoroethylene-hexafluoropropylene-vinylidenflouri-de-copolymer (THV), polyethylene terephthalate (PET), ethylene vinyl acetate (EVA), and/or Mylar®. Mylar is a registered trademark of E. I. du Pont de Nemours and Company of Wilmington, Del. Inorganic materials, such as glass and plastic foils, metalized plastic foils, and metal foils may also be used for the encapsulant layer. The encapsulant layer may also include nitrides, oxides, oxynitrides or other inorganic materials. Alternatively, the encapsulants may include Tefzel® (DuPont), tefdel, thermoplastics, polyimides, polyamides, nanolaminate composites of plastics and glasses (e.g. barrier films), and combinations of the above. For example, a thin layer of (relatively expensive) EVA/polyimide can be laminated to thick layer of (much less expensive) PET.

It is understood that the above-described preferred embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A product display system for holding a product, comprising:
a housing configured to contain the product;
a power source coupled to the housing and configured to provide electrical power;
an electronic paper display coupled to the housing, electrically coupled to the power source, and configured to visually display
a first image; and
a second image;
a processor in electrical communication with the electronic paper display and configured to control display of the first and second images; and
a memory module in communication with the electronic paper display and configured to store information regarding the first and second images.

2. The product display system of claim 1, further comprising an activation module in electrical communication with at least one of the group consisting of the electronic paper display, the processor, and the power source, wherein the activation module selectably restricts power consumption from the power source.

3. The product display system of claim 2, wherein the activation module comprises a light detector and wherein the activation module permits power consumption when light is detected by the light detector and restricts power consumption when light is not detected by the light detector.

4. The product display system of claim 1, further comprising a solar cell electrically coupled to the power source and configured to provide power to the power source when exposed to light.

5. The product display system of claim 1, further comprising an interface module in removable communication with the memory module.

6. The product display system of claim 1, further comprising a second electronic paper display coupled to the housing, electrically coupled to the power source, and configured to visually display
a third image; and
a fourth image.

7. The product display system of claim 1, further comprising an audio module in electrical communication with the power module.

8. A product display system for attaching to a product, comprising:
a power module configured to provide power;
a display module in electrical communication with the power module and configured to selectably display visual information;
an operating module in communication with the display module and configured to control the display module; and
a coupling module coupled to each of the power module, the display module, and the operating module and configured to couple the product display system to the product.

9. The product display system of claim 8, wherein the product is selected from the group of products consisting of CDs, DVDs, billboards, cereal boxes, and greeting cards.

10. The product display system of claim 8, wherein the coupling module comprises:
an adhesive layer coupled to the display module; and
a release layer coupled to the adhesive layer and configured to be removed without substantially removing the adhesive layer thereby exposing the adhesive layer.

11. The product display system of claim 8, further comprising a backlight module disposed behind the display module and configured to emit light through the display module.

12. The product display system of claim 8, further comprising an interface module removably coupled to the operating module and in communication therewith.

13. The product display system of claim 12, wherein the interface module comprises a perforated tab extending from the operating module.

14. The product display system of claim 8, wherein the power module comprises a sheet battery.

15. A product display system for containing a product, comprising:
a power module configured to provide power;
a display module in power communication with the power module and configured to selectably display visual information;
an operating module in communication with the display module and configured to control the display module; and
a housing module coupled to the display module and configured to contain the product.

16. The product display system of claim 15, further comprising a recharging module in electrical communication with the power module and configured to supply power to the power module.

17. The product display system of claim 15, wherein the housing module comprises being substantially ensconced by the display module.

18. The product display system of claim 15, wherein the display module comprises a protective sleeve.

19. The product display system of claim 15, further comprising an interface module removably coupled to the operating module and in communication therewith.

20. The product display system of claim 15, wherein the display module comprises electronic paper.

21. The product display system of claim 2, wherein the activation module further comprises being squeeze actuatable and upon actuation causes a display change from the first image to the second image.

22. The product display system of claim 2, further comprising a flap in communication with the activation module, wherein the activation module further comprises being pressure actuatable and moving the flap actuates the activation module thereby causing a display change from the first image to the second image.
